(19) United States
(12) Patent Application Publication
(10) Pub. No.: US 2015/0248320 A1
(43) Pub. Date: Sep. 3, 2015

(54) HOST-STORAGE CONNECTIVITY MONITORING

(71) Applicant: RED HAT ISRAEL, LTD., Ra'anana (IL)

(72) Inventor: Liron Aravot, Ramat-Gan (IL)

(73) Assignee: RED HAT ISRAEL, LTD., Ra'anana (IL)

(21) Appl. No.: 14/194,093

(22) Filed: Feb. 28, 2014

(51) Int. Cl. G06F 11/07

(52) U.S. Cl. CPC G06F 11/0727

(57) ABSTRACT

Systems and methods for host-storage connectivity monitoring. An example method may include: receiving first status information from a first host connected to a storage domain, processing the first status information to determine an operation status of the storage domain with respect to the first host, comparing the operation status of the storage domain with respect to the first host with an operation status of the storage domain with respect to a second host, and, in response to a determination that both the operation status of the storage domain with respect to the first host and the operation status of the storage domain with respect to the second host include one or more errors, maintaining an operational accessibility of the first host.

### TECHNICAL FIELD

Implementations of the present disclosure relate to a computing system, and more specifically, to host-storage connectivity monitoring.

### BACKGROUND

Virtualization entails running programs, usually multiple operating systems, concurrently and in isolation from other programs on a single system. Virtualization allows, for example, consolidating multiple physical servers into one physical server running multiple virtual machines in order to improve the hardware utilization rate. Virtualization may be achieved by running a software layer, often referred to as “hypervisor,” above the hardware and below the virtual machines. A hypervisor may run directly on the server hardware without an operating system beneath it or as an application running under a traditional operating system. A hypervisor may abstract the physical layer and present this abstraction to virtual machines to use, by providing interfaces between the underlying hardware and virtual devices of virtual machines. A hypervisor may save a state of a virtual machine at a reference point in time, which is often referred to as a snapshot. The snapshot can be used to restore or rollback the virtual machine to the state that was saved at the reference point in time.

### DESCRIPTION OF DRAWINGS

The details of one or more implementations are set forth in the accompanying drawings and the description below. Other features and advantages will be apparent from the description and drawings, and from the claims.

FIG. 1 is a block diagram of a host computer system in accordance with some implementations.

FIG. 2 is a flow diagram of a method for host-storage connectivity monitoring in accordance with some implementations.

FIG. 3 is a schematic diagram that shows an example of a machine in the form of a computer system.

### DETAILED DESCRIPTION

The present disclosure pertains to host-storage connectivity monitoring.

It can be appreciated that, in various systems it may be necessary to monitor the status of various hosts and/or storage devices that are incorporated within a system. In many scenarios, a host controller can be connected to several hosts which, in turn, may be connected to a single storage device. Given such architecture, various aspects of the storage device (e.g., the connectivity/accessibility status of such a device) can only be determined (e.g., by the host controller) via communication with those host(s) that are, in turn, connected to the storage device itself. Additionally, in scenarios in which various communication problems/errors are detected with respect to such a storage device, existing technologies may impute such a status to various connected hosts as well (e.g., by attributing a ‘down’ status to such host(s)), despite the fact that such hosts may be otherwise operational and the error or problem may lie in the storage device).

Accordingly, described herein are various technologies that enable improved monitoring and determinations of the status/state of a particular host, such as with respect to the connectivity of such a host with a storage domain. For example, in certain implementations status information can be received from a first host which can reflect various aspects of the connectivity between such a host and a storage domain. Such status information can be processed to determine an operation status of the storage domain with respect to the first host (e.g., whether or not a reliable connection is present between the host and the storage domain or whether various errors/problems are present with respect to such a connection). The operation status of the storage domain with respect to the first host can then be compared with other operation status(es) of the storage domain computed with respect to other host(s) that are connected to the same storage domain. Based on a determination that comparable errors are reflected across the operation status(es) of the storage domain as computed with respect to different hosts, it can be determined that the storage domain is likely the source of the error/problem and an operational accessibility of the first host can therefore be maintained (e.g., to facilitate various recovery operations, in lieu of otherwise ascribing a ‘down’ status to such a host and precluding such operations).

In the following description, numerous details are set forth. It will be apparent, however, to one skilled in the art, that the present disclosure may be practiced without these specific details. In some instances, well-known structures and devices are shown in block diagram form, rather than in detail, in order to avoid obscuring the present disclosure.

For brevity, simplicity and by way of example, a host controller performs many of the operations described herein. It is contemplated that other actors may perform some or all of the operations described herein, including a host computer system, a host operating system, multiple hypervisors, a disk image manager, and the like, including a combination thereof.

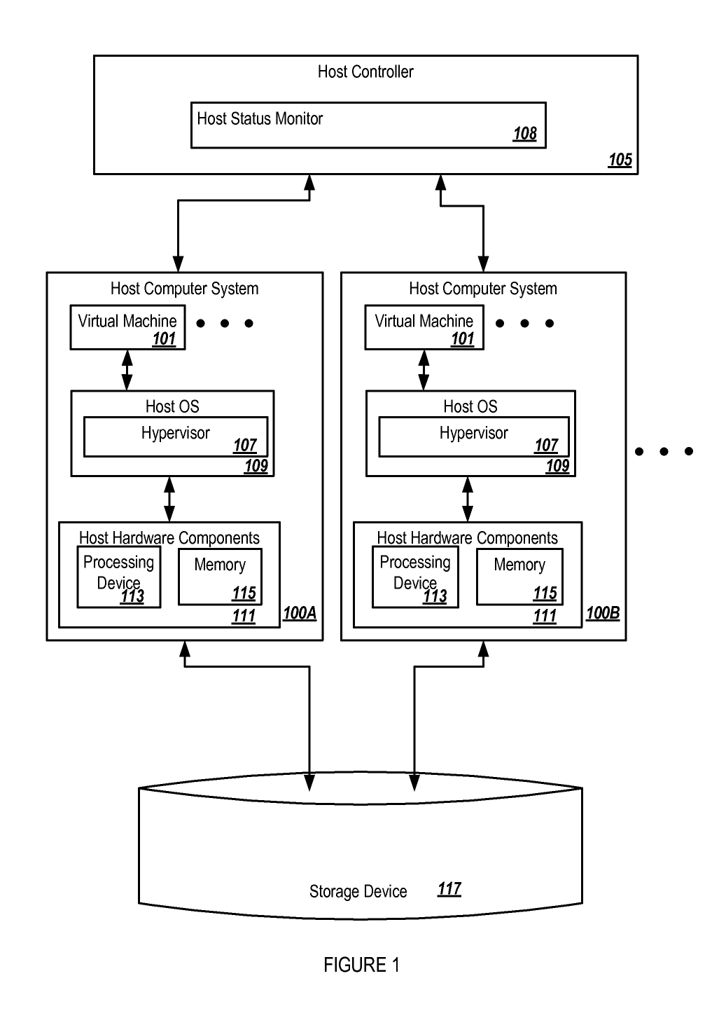

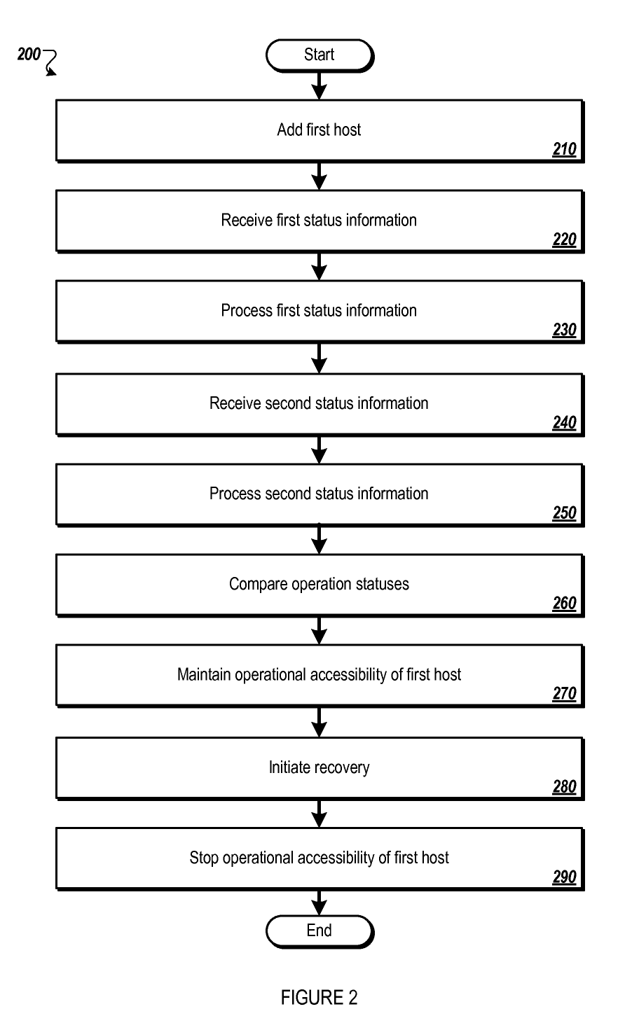

FIG. 1 is a block diagram that illustrates examples of a host controller 105 which is connected to and/or otherwise in communication with various host computer systems 100A, 100B, etc., each of which can hosts one or more VMs 101. The host controller 105 may be a server, a workstation, a personal computer (PC), a mobile phone, a palm-sized computing device, a personal digital assistant (PDA), etc. Host controller 105 may manage one or more host computers (e.g., hosts 100A, 100B, etc.) and/or virtual machines running thereon, including virtual machines 101, such as via host status monitor 108, such as is described herein. Some implementations of host status monitor 108 will be discussed in more detail below in conjunction with FIG. 2. Each VM can run a guest operating system (OS). The VMs may have the same or different guest operating systems, such as Microsoft Windows®, Linux®, Solaris®, Mac® OS, etc. The host computer system 100 may be a server, a workstation, a personal computer (PC), a mobile phone, a palm-sized computing device, a personal digital assistant (PDA), etc.

Each host computer system 100 can run a hypervisor 107 to virtualize access to the underlying host hardware, making the use of the VM transparent to the guest OS and a user of the host computer system 100. The hypervisor 107 may also be known as a virtual machine monitor (VMM) or a kernel-based hypervisor. The hypervisor 107 may be part of a host OS 109 (as shown in FIG. 1), run on top of the host OS 109, or run directly on the host hardware without an operating system beneath it (i.e., bare metal). The host OS 109 can be the same OS as the guest OS, or can be a different OS.

Each host computer system 100 includes hardware components 111 such as one or more physical processing devices (e.g., central processing units (CPUs)) 113, memory 115 (also referred to as “host memory” or “physical memory”) and other hardware components. In one implementation, the host computer system 100 includes one or more physical devices (not shown), which can be audio/video devices (e.g., video cards, sounds cards), network interface devices, printers, graphics modules, graphics devices, system components (e.g., PCI devices, bridges, ports, buses), etc. It is understood that the host computer system 100 may include any number of devices.

The host computer system 100 may also be coupled to one or more storage domains such as storage devices 117 via a direct connection or a network. The storage device 117 may be an internal storage device or an external storage device. Examples of storage devices include hard disk drives, optical drives, tape drives, solid state drives, and so forth. Storage devices may be accessible over a local area network (LAN), a wide area network (WAN) and/or a public network such as the internet. Examples of network storage devices include network attached storage (NAS), storage area networks (SAN), cloud storage (e.g., storage as a service (SaaS)), and so forth. The storage device 117 may store one or more files and/or other data. It should be understood that when the host computer system 100 is attached to multiple storage devices 117, some files may be stored on one storage device, while other files may be stored on another storage device. Additionally, as depicted in FIG. 1, multiple hosts (e.g., 100A and 100B) can be connected to a single storage device 117.

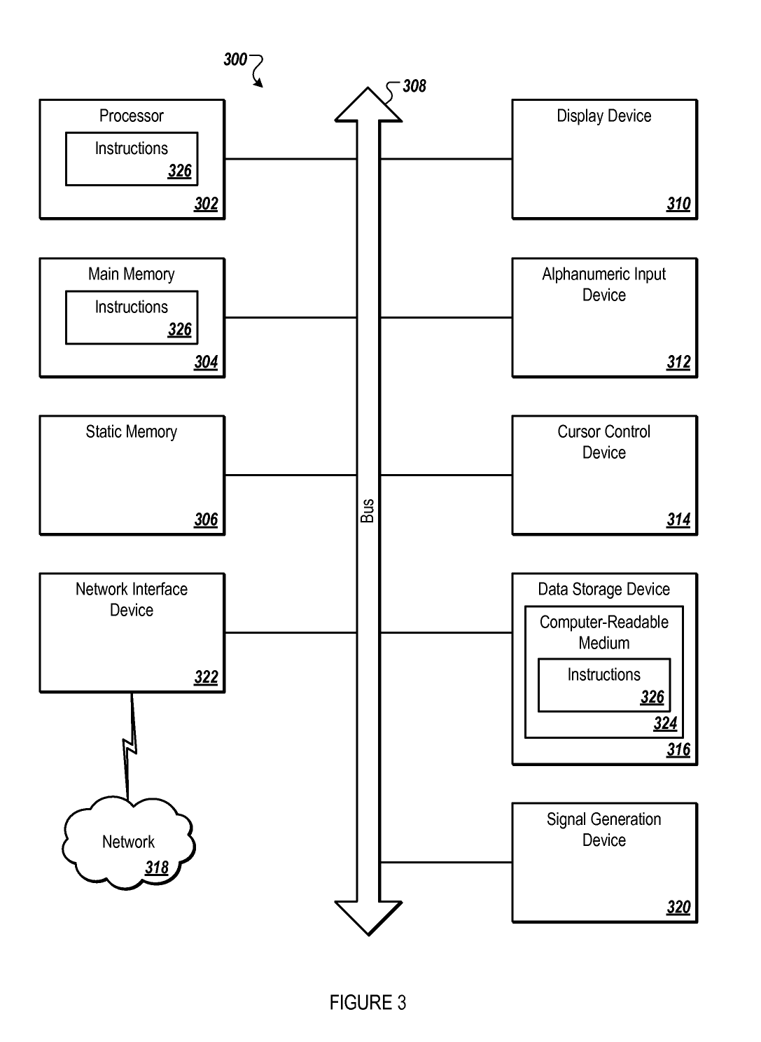

FIG. 2 is a flow diagram of a method 200 for to host-storage connectivity monitoring in accordance with some implementations. Method 200 can be performed by processing logic (e.g., in computing system 300 of FIG. 3) that may comprise hardware (e.g., circuitry, dedicated logic, programmable logic, microcode, etc.), software (such as instructions run on a processing device), firmware, or a combination thereof. In one implementation, method 200 is performed by host status monitor 108 and/or host controller 105 of FIG. 1. For clarity of presentation, the description that follows uses the system 100 as examples for describing the method 200. However, another system, or combination of systems, may be used to perform the method 200.

At block 210, a host (e.g., a computer, server, etc.) can be added to a system, such as a system that includes another host. For example, as depicted in FIG. 1, host 100A can be added (e.g., by host status monitor 108 and/or host controller 105) to a system (e.g., a networked system of devices) that also includes host 100B. Additionally, as depicted in FIG. 1, a connection (e.g., a network connection) can be initiated, established, and/or otherwise attempted to be established between the added host and one or more storage domain(s), such as storage device 117. The host can be added upon receiving a notification that the host is connected to the host controller and/or the storage domain.

At block 220, first status information can be received (e.g., by host status monitor 108 and/or host controller 105). In certain implementations, such first status information can be received from a first host (e.g., the first host that was added to the system at block 210). As noted, such a first host (e.g., host 100A as depicted in FIG. 1) can be connected to a storage domain (e.g., storage device 117) (or such a connection can be attempted to be established). The referenced first status information (which can be provided by the first host, e.g., host 100A) can include various indicators, parameters, values, etc., which can reflect various aspects of the operation of the host, the operation of the storage domain, and/or the state or status of the connection between the two. Examples of such first status information include, but are not limited to connection time information (e.g., the amount of time that a connection between the first host and the storage domain has been present), connection speed information (e.g., the average connection speed of the connection between the first host and the storage domain) and/or connection latency information (e.g., the latency of the connection between the first host and the storage domain).

At block 230, the first status information (e.g., the first status information received at block 220) can be processed (e.g., by host status monitor 108 and/or host controller 105). In doing so, an operation status of the storage domain can be determined, such as with respect to the first host. Such an operation status can reflect, for example, the state of the connection between the first host (e.g., host 100A) and a storage device (e.g., storage device 117). For example, by processing the first status information received at block 220 (e.g., the duration, speed, latency, etc., of a connection between the first host and the storage domain) and operation status (e.g., adequate/inadequate connection, accessible/inaccessible, etc.) can be determined.

At block 240, second status information can be received (e.g., by host status monitor 108 and/or host controller 105). Such second status information can be received from a second host (e.g., host 100B as depicted in FIG. 1). As noted, such a second host can be connected to the same storage domain (e.g., storage device 117) that the first host (e.g., the host added to the system at block 210) (or such a connection can be attempted to be established). The referenced second status information (which can be provided by the second host, e.g., host 100B) can include various indicators, parameters, values, etc., which can reflect various aspects of the operation of the host, the operation of the storage domain, and/or the state or status of the connection between the two. Examples of such first status information include, but are not limited to connection time information (e.g., the amount of time that a connection between the second host and the storage domain has been present), connection speed information (e.g., the average connection speed of the connection between the second host and the storage domain) and/or connection latency information (e.g., the latency of the connection between the second host and the storage domain).

At block 250, the second status information (e.g., the second status information received at block 240) can be processed (e.g., by host status monitor 108 and/or host controller 105). In doing so, an operation status of the storage domain can be determined, such as with respect to the second host. Such an operation status can reflect, for example, the state of the connection between the second host (e.g., host 100B) and a storage device (e.g., storage device 117).

At block 260, the operation status of the storage domain (e.g., storage device 117) with respect to the first host (e.g., as determined at block 230) can be compared (e.g., by host status monitor 108 and/or host controller 105) with the operation status of the storage domain with respect to a second host (e.g., as determined at block 250) (and/or with respective operation statuses of the storage domain as determined with respect to any number of other hosts that may also be connected to the storage domain). In doing so, it can be determined whether (or not) the various hosts that are connected to the same storage domain exhibit the same/comparable operation statuses (and thus the source of a connection error/problem may be likely to be the storage domain) or whether the various hosts exhibit considerably different operation statuses (and thus the source of a connection error/problem may be likely to be the host with respect to which it is identified, and not the storage domain).

At block 270, an operational accessibility of the first host (e.g., host 100A) can be maintained (e.g., by host status monitor 108 and/or host controller 105). In certain implementations, such an operational accessibility of the first host can be maintained based on/in response to a determination that the operation status of the storage domain with respect to the first host (e.g., as determined at block 230) and the operation status of the storage domain with respect to a second host (e.g., as determined at block 250) can both include one or more errors. Such errors can reflect, for example, that each respective host cannot connect to and/or otherwise access the storage domain (and/or cannot connect to/access the storage domain in a manner that is sufficient to perform one or more operations in relation to the storage domain, e.g., in a scenario in which the speed, latency, etc., of such a connection does not meet a minimum threshold/requirement). That is, having determined that both the first host (e.g., host 100A) and the second host (e.g., host 100B) exhibit comparable connectivity (and/or other) errors with respect to the storage domain, it can be further determined that such hosts are likely to be operating properly, and that the errors (which can be observed to be present with respect to both the first host and the second host) are likely to originate at the storage domain (and not the hosts).

At block 280, a recovery operation can be initiated, such as in relation to the first host (e.g., host 100A). That is, having determined (e.g., at block 270) that a particular host is likely to be operating properly, maintaining operation of such a host (e.g., in lieu of otherwise stopping the operational accessibility of such a host) can be continued and one or more recovery operations can be initiated at the host (e.g., by host status monitor 108 and/or host controller 105). Such operations can, for example, request additional information from the host, such as in order to attempt to repair the connection between the host and the storage device, to backup and/or transfer data stored on the host, connect the host to another storage device, etc. Additionally, in certain implementations the referenced recovery operation can be initiated (e.g., by host status monitor 108 and/or host controller 105) at/in relation to the storage domain, such as in order to attempt to repair various aspects/operations of the storage device (e.g., in a scenario in which it is determined that the source of the problem/error is the storage device).

At block 290, the operational accessibility of the first host can be stopped. In certain implementations, such an operational accessibility of the first host can be stopped (e.g., by host status monitor 108 and/or host controller 105) based on/in response to a determination that the operation status of the storage domain with respect to the first host (e.g., as determined at block 230) includes one or more errors and the operation status of the storage domain with respect to a second host (e.g., as determined at block 250) does not include one or more errors (and/or does not include the same and/or comparable errors as the the operation status of the storage domain with respect to the first host). That is, having determined that while the first host (e.g., host 100A) exhibits certain connectivity (and/or other) errors with respect to the storage domain, the second host (e.g., host 100B) does not exhibit the same and/or comparable errors, it can be further determined that the source of the connectivity error(s) with respect to the first host is likely to be the first host itself (and not the storage domain, as the second host does not exhibit the same/comparable errors and may otherwise be able to connect normally to the storage domain).

FIG. 3 is a schematic diagram that shows an example of a machine in the form of a computer system 300. The computer system 300 executes one or more sets of instructions 326 that cause the machine to perform any one or more of the methodologies discussed herein. The machine may operate in the capacity of a server or a client machine in client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions 326 to perform any one or more of the methodologies discussed herein.

The computer system 300 includes a processor 302, a main memory 304 (e.g., read-only memory (ROM), flash memory, dynamic random access memory (DRAM) such as synchronous DRAM (SDRAM) or Rambus DRAM (RDRAM), etc.), a static memory 306 (e.g., flash memory, static random access memory (SRAM), etc.), and a data storage device 316, which communicate with each other via a bus 308.

The processor 302 represents one or more general-purpose processing devices such as a microprocessor, central processing unit, or the like. More particularly, the processor 302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 302 may also be one or more special-purpose processing devices such as an application specific integrated circuit (ASIC), a field programmable gate array (FPGA), a digital signal processor (DSP), network processor, or the like. The processor 302 is configured to execute instructions of the host computer system 100 for performing the operations and steps discussed herein.

The computer system 300 may further include a network interface device 322 that provides communication with other machines over a network 318, such as a local area network (LAN), an intranet, an extranet, or the Internet. The computer system 300 also may include a display device 310 (e.g., a liquid crystal display (LCD) or a cathode ray tube (CRT)), an alphanumeric input device 312 (e.g., a keyboard), a cursor control device 314 (e.g., a mouse), and a signal generation device 320 (e.g., a speaker).

The data storage device 316 may include a computer-readable storage medium 324 on which is stored the sets of instructions 326 of the host computer system 100 embodying any one or more of the methodologies or functions described herein. The sets of instructions 326 of the host computer system 100 may also reside, completely or at least partially, within the main memory 304 and/or within the processor 302 during execution thereof by the computer system 300, the main memory 304 and the processor 302 also constituting computer-readable storage media. The sets of instructions 326 may further be transmitted or received over the network 318 via the network interface device 322.

While the example of the computer-readable storage medium 324 is shown as a single medium, the term “computer-readable storage medium” can include a single medium or multiple media (e.g., a centralized or distributed database, and/or associated caches and servers) that store the sets of instructions 326. The term “computer-readable storage medium” can include any medium that is capable of storing, encoding or carrying a set of instructions for execution by the machine and that cause the machine to perform any one or more of the methodologies of the present disclosure. The term “computer-readable storage medium” can include, but not be limited to, solid-state memories, optical media, and magnetic media.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, it is appreciated that throughout the description, discussions utilizing terms such as “receiving”, “processing”, “comparing”, “maintaining”, or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same implementation unless described as such.

It is to be understood that the above description is intended to be illustrative, and not restrictive. Other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving first status information from a first host connected to a storage domain;
processing the first status information to determine an operation status of the storage domain with respect to the first host;
comparing, by a processing device, the operation status of the storage domain with respect to the first host with an operation status of the storage domain with respect to a second host; and
in response to a determination that both the operation status of the storage domain with respect to the first host and the operation status of the storage domain with respect to the second host include one or more errors, maintaining an operational accessibility of the first host.

2. The method of claim 1, further comprising receiving second status information from the second host connected to the storage domain.

3. The method of claim 2, further comprising processing the second status information to determine an operation status of the storage domain with respect to the second host.

4. The method of claim 1, further comprising initiating a recovery operation in relation to the first host.

5. The method of claim 1, wherein the first status information comprises at least one of: connection time information, connection speed information, or connection latency information.

6. The method of claim 1, further comprising in response to a determination that the operation status of the storage domain with respect to the first host includes one or more errors and the operation status of the storage domain with respect to the second host does not include one or more errors, stopping the operational accessibility of the first host.

7. The method of claim 1, further comprising adding the first host to a system that includes the second host upon receiving a notification that the host is connected to at least one of a host controller or the storage domain.

8. A system comprising:
a memory; and
a processing device, coupled to the memory, to:
receive first status information from a first host connected to a storage domain;
process the first status information to determine an operation status of the storage domain with respect to the first host;
compare the operation status of the storage domain with respect to the first host with an operation status of the storage domain with respect to a second host; and
maintain an operational accessibility of the first host in response to a determination that both the operation status of the storage domain with respect to the first host and the operation status of the storage domain with respect to the second host include one or more errors.

9. The system of claim 8, wherein the processing device is further to receive second status information from the second host connected to the storage domain.

10. The system of claim 9, wherein the processing device is further to process the second status information to determine an operation status of the storage domain with respect to the second host.

11. The system of claim 8, wherein the processing device is further to initiate a recovery operation in relation to the first host.

12. The system of claim 8, wherein the first status information comprises at least one of: connection time information, connection speed information, or connection latency information.

13. The system of claim 8, wherein the processing device is further to stop the operational accessibility of the first host in response to a determination that the operation status of the storage domain with respect to the first host includes one or more errors and the operation status of the storage domain with respect to a second host does not include one or more errors.

14. The system of claim 8, wherein the processing device is further to add the first host to a system that includes the second host.

15. A non-transitory computer-readable storage medium having instructions that, when executed by a processing device, cause the processing device to perform operations comprising:
receiving first status information from a first host connected to a storage domain;
processing the first status information to determine an operation status of the storage domain with respect to the first host;
comparing, by the processing device, the operation status of the storage domain with respect to the first host with an operation status of the storage domain with respect to a second host; and
in response to a determination that both the operation status of the storage domain with respect to the first host and the operation status of the storage domain with respect to the second host include one or more errors, maintaining an operational accessibility of the first host.

16. The non-transitory computer-readable storage medium of claim 15, further comprising receiving second status information from the second host connected to the storage domain.

17. The non-transitory computer-readable storage medium of claim 16, further comprising processing the second status information to determine an operation status of the storage domain with respect to the second host.

18. The non-transitory computer-readable storage medium of claim 15, further comprising initiating a recovery operation in relation to the first host.

19. The non-transitory computer-readable storage medium of claim 15, wherein the first status information comprises at least one of: connection time information, connection speed information, or connection latency information.

20. The non-transitory computer-readable storage medium of claim 15, further comprising in response to a determination that the operation status of the storage domain with respect to the first host includes one or more errors and the operation status of the storage domain with respect to a second host does not include one or more errors, stopping the operational accessibility of the first host.
